(19) United States
(12) Patent Application Publication
(10) Pub. No.: US 2003/0220430 A1
(43) Pub. Date: Nov. 27, 2003

(54) Rubber compounds containing terpolymers

(76) Inventors: Adrian Rawlinson, Leverkusen (DE); Rudiger Engehausen, Dormagen (DE); Peter Wendling, Leverkusen (DE)

Correspondence Address: BAYER POLYMERS LLC, 100 BAYER ROAD, PITTSBURGH, PA, 15205, US

(21) Appl. No.: 10/436,024

(22) Filed: May 12, 2003

(30) Foreign Application Priority Data
May 14, 2002 (DE) 10221287.2

(51) Int. Cl. C08L 1/00

(52) U.S. Cl. 524/297

(57) ABSTRACT

The present invention concerns rubber compounds containing at least one NSBR terpolymer and at least one polar synthetic plasticizer, a process for their production and their use to produce rubber moldings of all types.

### FIELD OF THE INVENTION

The present invention relates to rubber compounds containing terpolymers based on an unsaturated olefinic nitrile, a vinyl aromatic compound and a conjugated diene along with at least one polar synthetic plasticizer. The rubber compounds according to the present invention can be used to produce rubber moldings, such as tires.

### BACKGROUND OF THE INVENTION

The use of terpolymers based on a conjugated diolefin, a vinyl aromatic compound and an olefinic unsaturated nitrile to improve wet skid resistance and abrasion resistance is known. See, for example EP-A 537 640, U.S. Pat. Nos. 5,310,815 and 5,225,479, DE-A 3 837 047, EP-A 0 736 399. The cited references also disclose that the terpolymers therein could be mixed with other rubbers, whereby the conventional rubber auxiliary substances can be added to these mixtures. Among the many different rubber auxiliary substances, plasticizers are also described as auxiliary substances that can be added by conventional means.

The terpolymers or mixtures thereof with other rubbers described in the cited references still have room for improvement however with regard to dynamic properties such as dynamic modulus at low temperatures and the combination of rolling resistance, wet skid resistance and abrasion properties.

It is known that tire tread compounds containing carbon black or silica and based on non-polar rubbers or mixtures thereof containing NSBR lead to a marked increase in the tan 6 value at 0° C., which indicates an improved wet skid resistance. Depending on the particular rubber compound an improved abrasion resistance is also found. The use of NSBR in such compounds also displays negative effects, however, such as a markedly increased dynamic modulus at 0° C. and an increased tan 6 value at 60° C. However, a tire tread compound having a high dynamic modulus at 0° C. has disadvantages at low temperatures in terms of ABS braking performance in wet conditions and road performance. A high tan δ value at 60° C. also indicates a higher rolling resistance.

Rubber compounds containing at least one terpolymer (NSBR) consisting of an olefinic unsaturated nitrile, a vinyl aromatic compound and a conjugated diene and at least one non-polar synthetic plasticizer are known from German patent application 10104 236.1, whereby the synthetic plasticizers are present in a quantity of 0.5 to 50 parts by weight, relative to the quantity of total rubber.

The object of the present invention is to provide rubber compounds based on terpolymers having the aforementioned composition, which display improved dynamic properties such as dynamic modulus at low temperatures and an improved combination of rolling resistance, wet skid performance and abrasion resistance properties.

The object is achieved by adding polar synthetic plasticizers to the rubber compounds containing terpolymers.

### SUMMARY OF THE INVENTION

The present invention is directed to rubber compounds containing

a) at least one terpolymer prepared by polymerizing an olefinic unsaturated nitrile, a vinyl aromatic compound and a conjugated diene and

b) at least one polar synthetic plasticizer,

whereby the component b) is present in quantities of 50.1 to 206 wt. %, relative to the quantity of terpolymer (a).

### DETAILED DESCRIPTION OF THE INVENTION

Preferably, component b) is present in quantities of 55 to 180 wt. %, in particular 60 to 150 wt. %, relative in each case to the quantity of terpolymer (a).

The terpolymer used as component a) in the rubber compounds according to the present invention is based—as mentioned—on unsaturated olefinic nitrites, vinyl aromatic compounds and conjugated dienes.

Examples of suitable conjugated dienes include: 1,3-butadiene, 2,3-dimethyl, 1,3-butadiene, 2-methyl-1,3-butadiene, 2-ethyl-1,3-butadiene, 1,3-pentadiene, 2-methyl-1,3-pentadiene, 1,3-hexadiene, 2-phenyl-1,3-butadiene, 3,4-dimethyl-1,3-hexadiene, 1,3-heptadiene, 1,3-octadiene, 4,5-diethyl-1,3-octadiene, 3-methyl-1,3-pentadiene, 4-methyl-1,3-pentadiene or mixtures of the cited dienes. 1,3-butadiene and 2-methyl-1,3-butadiene, are preferred 1,3-butadiene, is more preferred.

Suitable vinyl aromatic compounds include those containing 8 to 16 carbon atoms in the molecule, such as styrene, α-methyl styrene, 2-methyl styrene, 3-methyl styrene, 4-methyl styrene, 4-cyclohexyl styrene, 4-p-toluene styrene, p-chlorostyrene, p-bromostyrene, 4-tert.-butyl styrene, 1-vinyl naphthalene, 2-vinyl naphthalene or mixtures thereof, whereby styrene is preferred.

Acrylonitrile, methacrylonitrile, ethyl acrylonitrile, crotonic nitrile, 2-pentene nitrile or mixtures thereof can be used as olefinic unsaturated nitriles to form the terpolymers, whereby acrylonitrile is preferred.

The terpolymers for use according to the present invention contain the conjugated dienes in quantities of around 40 to 89 wt. %, the vinyl aromatic compounds in quantities of around 10 to 40 wt. % and the olefinic unsaturated nitriles in quantities of around 1 to 50 wt. %, whereby the quantities of individual components add up to 100 wt. %.

The conjugated dienes are preferably used in quantities of 40 to 80 wt. %, the vinyl aromatic compounds in quantities of 10 to 35 wt. % and the olefinic unsaturated nitriles in quantities of 10 to 40 wt. %.

Depending on the quantities of structural components used, the glass transition temperature of the terpolymers used according to the present invention is around −60 to 0° C., preferably −45 to −15° C.

The NSBR terpolymers used according to the present invention are known for example from the aforementioned patent publications, as is their production.

As has been mentioned, it is important for the physical properties of the rubber compounds according to the present invention, or of the vulcanizates or moldings produced from them, that polar synthetic plasticizers are added to the rubber compounds. Suitable polar synthetic plasticizers are those containing e.g. ester or ether groups in the molecule, for example phthalates, such as dibutyl phthalates (DBP), dioctyl phthalates (DOP), diisononyl phthalates (DINP), diisodecyl phthalates (DIDP), diisotridecyl phthalates (DTDP), diundecyl phthalates (DUP), sebacates, such as dioctyl sebacates (DOS), dibutyl sebacates (DBS), adipates, such as dioctyl adipates (DOA), diisodecyl adipates (DIDA), diisononyl adipates (DINA), di(butoxy ethoxy ethyl) adipates, phosphoric acid esters, such as tricresyl phosphates (TCP), trixylyl phosphates (TXP), trioctyl phosphates (TOF), diphenyl cresyl phosphates, diphenyl octyl phosphates, trichloroethyl phosphates, stearates, such as butyl stearate, azelates, such as dioctyl azelates, oleates, such as dibutyl oleate, trimellitates, such as trioctyl mellitate, trilinear C₇-C₉ trimellitates, glycolates, such as dibutyl methylene bis-thioglycolates, di-2-ethylhexyl ester thiodiglycolates, nylonates, such as dioctyl nylonate, diisodecyl nylonate, phenyl alkyl sulfonic acid esters, butyl carbitol formal, and mixed esters of adipic, glutaric and succinic acid.

Further examples of polar plasticizers include: chlorinated paraffins with a chlorine content of 40 to 70 wt. % and plasticizers based on epoxy esters, polyesters and polyethers, ether thioethers and phenolsulfonic acid esters.

The polar synthetic plasticizers can be used both individually and in mixtures with one another. The most favorable mixing ratio depends on the particular end use of the rubber compounds according to the present invention.

Plasticizers based on phthalic acid, sebacic acid and adipic acid of the above type are preferred.

In addition to the polar synthetic plasticizers the rubber compounds according to the present invention can of course also contain the known fillers and rubber auxiliary substances, such as pigments, zinc oxide, stearic acid, vulcanization accelerators, vulcanizing agents based on sulfur and peroxide for example, stabilizers, antioxidants, resins, oils, waxes and inhibitors.

Suitable fillers for the rubber compounds according to the present invention are the known carbon blacks and silicas and also silicates, titanium dioxide, chalk or clay or mixtures thereof. Carbon black and silica are preferably used as fillers.

If silicas are used in the rubber compounds, so-called filler activators, such as bis-3-(triethoxysilylpropyl) tetrasulfite, can also be added by known means.

The cited additives or auxiliary substances are likewise known to the person skilled in the art and are described inter alia in Kautschuk-Technology by Werner Hoffmann, Habilitationsschrift der Fakultät für Maschinenwesen, TH Aachen, 1975; Handbuch für die Gummuiindustrie, Bayer AG Leverkusen, Hoffmann, W.: Kautschuk-Technology Stuttgart (Genter 1980) and in Helle Füllstoffe in Polymeren, Gummi Faser Kunststoffe 42 (1989) no. 11.

The fillers and the cited rubber auxiliary substances are used in the conventional quantities. The preferred quantities in each case are governed inter alia by the intended application of the rubber compounds and can easily be determined by appropriate preliminary tests.

The rubber compounds according to the present invention can of course also contain other natural rubbers (NR) and synthetic rubbers, such as for example polybutadiene (BR), styrene-butadiene copolymers (SBR), polyisoprene rubbers (IR), isoprene-butadiene rubbers, isoprene-butadiene-styrene rubbers, ethylene-propylene rubbers. Polybutadiene, styrene-butadiene copolymers and natural rubbers are preferably used. Aromatic, naphthene- or paraffin-based oils can of course also be added—in the conventional way—to the aforementioned additional rubbers used in the rubber compounds according to the present invention.

The rubbers that are additionally to be used are conventionally produced by known means by radical emulsion polymerization, radical solution polymerization, anionic or cationic polymerization or by Ziegler-Natta polymerization.

The quantity of additional rubbers added can be varied widely and is governed above all by the subsequent application of the rubber compounds according to the present invention based on NSBR and synthetic plasticizers.

Generally speaking the cited, additional rubbers are used in quantities of 1 to 99, preferably 10 to. 90, most particularly preferably 20 to 80 wt. %, relative to the quantity of total rubber.

The rubber compounds according to the present invention can be produced by intensively mixing the individual components together in suitable mixing units, such as rolls or kneaders.

The rubber compounds according to the present invention are preferably produced by mixing component a), i.e. the terpolymer (NSBR) in latex form with the polar synthetic plasticizer(s) (component b)) and appropriately working up the mixture thus obtained by coagulation and subsequent drying.

The plasticizers can be added to the NSBR latex simply by mixing the two components. The plasticizer can also be added to the latex in the form of an aqueous emulsion, whereby conventional, known emulsifiers are added. Such emulsifiers that were also used in production of the latex can be used here. The use of other emulsifiers is of course also possible.

The NSBR latex/plasticizer mixture can be produced at room temperature but also at elevated temperature, particularly if the plasticizer to be added displays a high viscosity.

Coagulation of the latex/plasticizer mixture can be achieved by known and conventional methods. Examples include the introduction of mechanical energy, whereby coagulation occurs due to shearing, the use of purely thermal processes or the addition of precipitating agents, such as alkali, alkaline-earth or aluminum salts or inorganic or organic acids, whereby the use of auxiliary precipitating agents such as gelatine and/or polyelectrolytes is also possible. The use of precipitating agents of the cited type is preferred.

The coagulated mixture can undergo one or more washing stages, by known means, whereby a preliminary dewatering in suitable equipment, for example in a dewatering screw, is possible before the coagulated mixture is dried.

The fillers and rubber auxiliary substances described above can then be added by known means to the coagulated and dried rubber compounds that are obtained.

The rubber compounds according to the present invention can be vulcanized by conventional means, whereby the most convenient vulcanization method depends on the intended application of the rubber compounds.

The rubber compounds according to the present invention can be used to produce vulcanizates of all types, such as to produce tire components and to produce industrial rubber goods such as belts, seals and hoses.

The use of the rubber compounds according to the present invention in tire construction, such as for tire treads, is preferred.

In the following examples the properties of the rubber compounds according to the present invention, the comparative rubber compounds and the resulting vulcanizates were measured as follows:

(1) The polymer composition was measured by IR spectroscopy.

(2) The Mooney viscosity of the rubbers was determined according to DIN 53523.

(3) The tensile strength of the vulcanizates was determined according to DIN 53504.

(4) The elongation at break of the vulcanizates was determined according to DIN 53504.

(5) The modulus of the vulcanizates at 100 and 300% elongation was determined according to DIN 53504.

(6) The hardness of the vulcanizates at 70° C. was determined according to DIN 53505.

(7) The abrasion of the vulcanizates was determined according to DIN 53516.

(8) The tan δ, E*, E′ and E″ of the vulcanizates were determined according to DIN 53513.

### EXAMPLES

The following components were used for the comparative rubber compound 1 and 2 and for the rubber compounds 1, 2 and 3 according to the present invention:

NSBR (rubber produced by emulsion polymerization, 58.5% butadiene, 20.3% styrene and 21.1% acrylonitrile, Mooney viscosity 49), Krylene® 1500 (emulsion SBR, 23.5% styrene, manufactured by Bayer Elastomeres),

Renopal® 450 (aromatic mineral oil plasticizer, manufactured by Fuchs Chemie),

Corax® N339 (carbon black, manufactured by Degussa Hüls AG), stearic acid,

ZnO (zinc oxide),

sulfur,

Vulkanox® 4010 (N-isopropyl-N′-phenyl-p-phenylene diamine, manufactured by Bayer AG),

Vulkanox® 4020 (N-(1,3-dimethyl butyl)-N′-phenyl-p-phenylene diamine, manufactured by Bayer AG),

Vulkacit® D (diphenyl guanidine, manufactured by Bayer AG),

Vulkacit® CZ/C (N-cyclohexyl-2-benzothiazyl sulfenamide, manufactured by Bayer AG),

DOP: Vestinol AH, (dioctyl phthalate, Hüls AG),

DOS: Edenol 888, (dioctyl sebacate, Henkel KGaA).

The individual percentages by weight of the components are listed in Table 1.

The components were mixed in a kneader (Wemer & Pfleiderer GK 1.5) at 50 rpm. The kneader temperature was 60° C. The vulcanization accelerators were added on a roll.

The results of the tests are listed in Table 1.

TABLE 1

| | | Example | Example | Comp. |
|---|---|---|---|---|
| | | 1 | 2 | example 1 |
| Krylene ® 1500 | | 80 | 80 | 80 |
| NSBR | | 20 | 20 | 20 |
| Corrax ® N339 | | 50 | 50 | 50 |
| Aromatic oil | | 15 | 15 | 30 |
| DOP | | 15 | 0 | 0 |
| DOS | | 0 | 15 | 0 |
| Stearic acid | | 2 | 2 | 2 |
| Zinc oxides | | 3 | 3 | 3 |
| Vulkanox ® 4010 | | 1 | 1 | 1 |
| Vulkanox ® 4020 | | 1 | 1 | 1 |
| Sulfur | | 2 | 2 | 2 |
| Vulkacit ® CZ/C | | 1.5 | 1.5 | 1.5 |
| Vulkacit ® D | | 0.2 | 0.2 | 0.2 |
| Tensile strength (MPa) | | 21.1 | 20.6 | 21.1 |
| Elongation at break (%) | | 635 | 625 | 640 |
| Modulus 100% (MPa) | | 1.5 | 1.5 | 1.6 |
| Modulus 300% (MPa) | | 6.6 | 6.7 | 6.5 |
| Hardness 23° C. (Shore A) | | 57 | 55 | 57 |
| Hardness 70° C. (Shore A) | | 51 | 51 | 51 |
| DIN abrasion 60 (mm³) | | 130 | 115 | 140 |
| tan δ | 0° C. | 0.477 | 0.496 | 0.463 |
| | 23° C. | 0.278 | 0.273 | 0.339 |
| | 60° C. | 0.193 | 0.187 | 0.216 |
| E* (complex modulus) | | 19.489 | 16.723 | 62.777 |
| | 0° C. | | | |
| | 23° C. | 8.573 | 7.376 | 10.555 |
| | 60° C. | 5.424 | 5.438 | 5.727 |
| E′ (storage modulus) | | 17.589 | 14.983 | 56.973 |
| | 0° C. | | | |
| | 23° C. | 8.261 | 7.115 | 9.995 |
| | 60° C. | 5.326 | 5.346 | 5.598 |
| E″ (loss modulus) | | 8.394 | 7.429 | 26.365 |
| | 0° C. | | | |
| | 23° C. | 2.294 | 1.945 | 3.391 |
| | 60° C. | 1.025 | 1 | 1.209 |

The results in Table 1 show that with comparable mechanical properties the rubber compounds according to the invention display advantages over the prior art in terms of properties such as markedly low dynamic moduli, higher tan 6 values at 0° C. (better wet skid resistance), low tan δ values at 60° C. (lower rolling resistance) and lower DIN abrasion (lower wear).

### Example 3

### Production of the Rubber Compounds According to the Invention by the Latex Method

Production of the Terpolymer

1631.25 g styrene, 7.13 g tert.-dodecyl mercaptan, 900 g acrylonitrile and a solution consisting of 7537.4 g demineralised water, 197.68 g disproportionated rosin acid (sodium salt, 70%), 2175 g partially hydrogenated tallow fatty acid (potassium salt, 9%), 14.06 g potassium hydroxide (85%), 32.06 g condensed naphthalene sulfonic acid (Na salt) and 14.63 g potassium chloride were placed in an evacuated, stirrable 20 l steel reactor. All components were rinsed with nitrogen in advance. 3093 g butadiene were then added and the emulsion heated to 10° C. with stirring. Polymerization was initiated by addition of 1.52 g p-menthane hydroperoxide (50%) and a solution consisting of 167.91 g demineralised water, 1.69 g EDTA, 1.35 g iron(II) sulfate*7H₂O, 3.46 g sodium formaldehyde sulfoxylate and 5.23 g sodium phosphate*12H₂O and continued at 10° C.

At a conversion of 81.4% polymerization was stopped by addition of 22.5 g diethyl hydroxylamine (25%) and 1.13 g sodium dithionite. 13.50 g Vulkanox® BKF (2,2′-methylene-bis-(4-methyl-6-tert.-butyl phenol, product manufactured by Bayer AG Leverkusen), added as a 46% dispersion (29.35 g), were added to the latex. The unreacted butadiene was degassed and the unreacted monomers removed from the latex using steam. A small sample was coagulated and the polymer dried. The polymer displayed a Mooney viscosity (ML1+4) of 155. The polymer composition was measured using IR spectroscopy as 56.8% butadiene, 23.4% styrene and 19.8% acrylonitrile. The gel content in toluene was 2.5%.

Production of the Latex-Plasticizer Mixture

700 g DOP (70 phr) were added to 3000 g of the latex, corresponding to 1000 g polymer. To this end the DOP was emulsified in an aqueous solution consisting of 500 g water, 0.41 g polynaphthaline sulfonic acid, 65 g disproportionated rosin acid, sodium salt (10%) and 14.5 g partially hydrogenated tallow fatty acid (potassium salt, 9%) with stirring. Latex and DOP emulsion were heated to 60° C. and mixed with stirring. Stirring was continued for 30 minutes.

Coagulation of the Latex-Plasticizer Mixture

10 kg of demineralised water at a temperature of 65° C., 825 g sodium chloride and 2.25 g polyamine (Superfloc® C567) were placed in a stirred reactor. The latex-plasticizer mixture was added at 65° C. with stirring. During this process the pH of the precipitating serum was adjusted to and held at 4 by addition of 10% sulfuric acid.

The precipitating serum was clear. The DOP-drawn rubber was filtered off and washed for 15 minutes with demineralised water at a temperature of 65° C. with stirring. The water:rubber ratio was 10:1. The wet, DOP-drawn rubber was dried at 70° C. in a vacuum drying cabinet. The Mooney viscosity (ML1+4) was 35 ME.

Testing of the Examples and Comparative Examples

The following components were used for the comparative rubber compounds and the rubber compounds according to the invention:

Masterbatch from Example 3

NSBR (rubber produced by emulsion polymerization, 58.5% butadiene, 20.3% styrene and 21.1% acrylonitrile, Mooney viscosity 49),

SBR 1500 (Krylene® 1500, emulsion SBR, 23.5% styrene, manufactured by Bayer Elastomeres),

Renopal® 450 (aromatic mineral oil plasticizer, manufactured by Fuchs Chemie),

Corax® N339 (carbon black, manufactured by Degussa Hüls AG),

stearic acid,

ZnO (zinc oxide),

sulfur,

Vulkanox® 4010 (N-isopropyl-N′-phenyl-p-phenylene diamine, manufactured by Bayer AG),

Vulkanox® 4020 (N-(1,3-dimethyl butyl)-N′-phenyl-p-phenylene diamine, manufactured by Bayer AG),

Vulkacit® D (diphenyl guanidine, manufactured by Bayer AG),

Vulkacit® CZ/C (N-cyclohexyl-2-benzothiazyl sulfenamide, manufactured by Bayer AG),

DOP: Vestinol AH, (dioctyl phthalate, Hüls AG).

The individual percentages by weight of the components and the results are listed in Table 2.

The components were mixed in a kneader (Werner & Pfleiderer GK 1.5) at 50 rpm. The kneader temperature was 60° C. The vulcanization accelerators were added subsequently on a roll.

TABLE 2

| | | | Example | Comp. |
|---|---|---|---|---|
| | | | 3 | example 2 |
| SBR 1500 | | | 80 | 80 |
| NSBR | | | 0 | 17.65 |
| Masterbatch with 70 phr DOP | | | 30 | 0 |
| Aromatic mineral oil | | | 17.65 | 30 |
| DOP | | | 0 | 0 |
| Carbon black N339 | | | 50 | 50 |
| Stearic acid | | | 2 | 2 |
| Zinc oxide | | | 3 | 3 |
| Vulkanox 4010 | | | 1 | 1 |
| Vulkanox 4020 | | | 1 | 1 |
| Sulfur | | | 2 | 2 |
| Vulkacit CZ | | | 1.5 | 1.5 |
| Vulkacit D | | | 0.2 | 0.2 |
| Parts by weight of synthetic | | | 12.35 | 0 |
| plasticizers in the mixture, | | | | |
| relative to rubber | | | | |
| Vulcanisate properties | | | | |
| Tensile strength | | (Mpa) | 23 | 21.1 |
| Elongation at break | | (%) | 630 | 640 |
| Modulus 100% | | (Mpa) | 1.7 | 1.6 |
| Modulus 300% | | (Mpa) | 7.5 | 6.5 |
| Hardness at 23° C. | | (Shore A) | 57 | 57 |
| Hardness at 70° C. | | (Shore A) | 52 | 51 |
| DIN abrasion 60 | | (mm³) | 95 | 140 |
| tan δ | 0° C. | | 0.53 | 0.463 |
| | 23° C. | | 0.285 | 0.339 |
| | 60° C. | | 0.172 | 0.216 |
| E* (complex modulus) | | | 19.257 | 62.777 |
| | 0° C. | | | |
| | 23° C. | | 8.359 | 10.555 |
| | 60° C. | | 5.025 | 5.2727 |
| E′ (storage modulus) | | | 17.245 | 59.973 |
| | 0° C. | | | |
| | 23° C. | | 8.212 | 9.995 |
| | 60° C. | | 5.002 | 5.598 |
| E″ (loss modulus) | | | 9.233 | 26.635 |
| | 0° C. | | | |
| | 23° C. | | 2.454 | 3.391 |
| | 60° C. | | 0.959 | 1.209 |

The results in Table 2 show that the masterbatch according to the invention displays advantages over the prior art (comparative example 2) such as a markedly low dynamic modulus at 0° C., higher tan δ value at 0° C. (better wet skid resistance), lower tan δ value at 60° C. (lower rolling resistance) and lower DIN abrasion (lower wear).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Rubber compounds comprising
a) at least one terpolymer prepared by polymerizing an olefinic unsaturated nitrile, a vinyl aromatic compound and a conjugated diene and
b) at least one polar synthetic plasticizer,
wherein the component b) is present in a quantity of 50.1 to 200 wt. %, relative to the quantity of component a).

2. Rubber compounds according to claim 1, wherein component b) is present in a quantity of 55 to 180 wt. %, relative to the quantity of component a).

3. Rubber compounds according to claim 2, wherein component b) is present in a quantity of 60 to 150 wt. %, relative to the quantity of component a).

4. Rubber compounds according to claim 1, further comprising at least one additional synthetic or natural rubber or mixtures thereof, whereby the quantity of the added rubbers is 1 to 99 wt. %, relative to the amount of total rubber.

5. Rubber compounds according to claim 1, wherein the conjugated diene is 1,3-butadeine, 2-methyl-1,3-butadiene or a mixture thereof.

6. Rubber compounds according to claim 1, wherein the vinyl aromatic compound is styrene.

7. Rubber compounds according to claim 1, wherein the olefinic unsaturated nitrile is acrylonitrile.

8. Rubber compounds according to claim 1, wherein the plasticizer is dibutyl phthalates, dioctyl phthalates, diisononyl phthalates, diisodecyl phthalates, diisotridecyl phthalates, diundecyl phthalates, dioctyl sebacates, dibutyl sebacates, dioctyl adipates, diisodecyl adipates, diisononyl adipates, di(butoxy ethoxy ethyl) adipates, tricresyl phosphates, trixylyl phosphates, trioctyl phosphates, diphenyl cresyl phosphates, diphenyl octyl phosphates, trichloroethyl phosphates, butyl stearate, dioctyl azelates, dibutyl oleate, trioctyl mellitate, trilinear C₇-C₉ trimellitates, dibutyl methylene bis-thioglycolates, di-2-ethylhexyl ester thiodiglycolates, dioctyl nylonate, diisodecyl nylonate, phenyl alkyl sulfonic acid esters, butyl carbitol formal, or mixed esters of adipic, glutaric and succinic acid.

9. A vulcanized rubber comprising a rubber compound comprising
a) at least one terpolymer prepared by polymerizing an olefinic unsaturated nitrile, a vinyl aromatic compound and a conjugated diene and
b) at least one polar synthetic plasticizer,
wherein the component b) is present in a quantity of 50.1 to 200 wt. %, relative to the quantity of component a).

10. A vulcanized rubber according to claim 9, in the form of a tire.

11. A process for preparing rubbers according to claim 1, comprising mixing the terpolymers in latex form with the polar synthetic plasticizers, coagulating the mixture obtained, and then drying the mixture.
